(19) United States
(12) Patent Application Publication
(10) Pub. No.: US 2017/0208280 A1
(43) Pub. Date: Jul. 20, 2017

(54) PIXEL APPARATUS, OPERATION METHOD THEREOF AND IMAGE SENSOR USING THE SAME

(71) Applicant: SK hynix Inc., Gyeonggi-do (KR)

(72) Inventor: Woong-Hee LEE, Gyeonggi-do (KR)

(21) Appl. No.: 15/186,149

(22) Filed: Jun. 17, 2016

(30) Foreign Application Priority Data
Jan. 19, 2016 (KR) 10-2016-0006288

(51) Int. Cl. H04N 5/374

(52) U.S. Cl. CPC H04N 5/3741

(57) ABSTRACT

A pixel apparatus may include a pixel unit suitable for outputting a pixel signal corresponding to incident light, a voltage supply unit suitable for supplying a reset voltage for a floating diffusion (FD) node of the pixel unit, and a voltage switching unit suitable for transferring the reset voltage from the voltage supply unit to the pixel unit during a first period from an exposure start time to just before a readout time, in response to a control signal.

### CROSS-REFERENCE TO RELATED APPLICATIONS

The present application claims priority of Korean Patent Application No. 10-2016-0006288, filed on Jan. 19, 2016, the disclosure of which is incorporated herein in its entirety by reference.

### BACKGROUND

1. Field

Exemplary embodiments of the present invention relate to a CMOS (complementary metal oxide semiconductor) image sensor (CIS) and, more particularly, to a pixel apparatus capable of preventing low-illumination properties from being degraded by a leak current which occurs in a floating diffusion (FD) node, an operation method thereof and a CIS using the same.

2. Description of the Related Art

FIG. 1 is a circuit diagram of a conventional four-transistor pixel which is publicly well-known, hence detailed descriptions thereof are omitted herein.

In a conventional pixel, as illustrated in FIG. 1, data stored in a photo diode (PD) is transferred to an FD node which is an input node (gate terminal) of a source follower transistor DX, through a transfer transistor TX. The data transferred to the FD node may change an output voltage of the source follower transistor DX, which is an output of the pixel.

In a conventional CIS, noise is easily introduced into a dark image or low-light image. Thus, the conventional CIS requires a technology for controlling a leak current which occurs in a PD or an FD node of a pixel for reducing the influence of noise in a dark condition or low-light condition on an image quality.

In general, the FD node may include the same type of impurity as the PD. In the case of a CIS which operates according to a rolling shutter method, the FD node is used as a node for reading a charge signal.

In the conventional CIS, when a transfer transistor TX is formed by anisotropic etching of polysilicon (Poly-Si), a crystal defect may occur around the gate edge of the transfer transistor TX.

While the transfer transistor TX is, turned off, an electric field is concentrated around the gate edge of the transfer transistor TX in which a crystal defect is likely to occur, due to a potential difference between the FD node and the gate terminal of the transfer transistor TX. As a result, a leak current may occur due to a crystal defect around the region where the electric field is concentrated, thereby degrading the quality of a dark image or a low-light image.

FIGS. 2A and 2B are diagrams illustrating signal readout timings of the conventional pixel of FIG. 1 and voltage changes of the FD node thereof.

FIG. 2A illustrates a case in which the FD node is set in a floating state from an exposure start time to just before a readout time.

FIG. 2B illustrates a case in which the FD node is reset from the exposure start time to just before the readout time.

When light is incident on the FD node or charge overflowing from the PD is introduced into the FD node during a period from the exposure start time to just before the readout time, the voltage of the FD node may be lowered as indicated by a reference numeral 21 in FIG. 2A.

There has been a growing tendency to increase the off potential of a transfer transistor TX (TX off potential) for securing the capacity of a PD. Thus, it has become important to control a blooming phenomenon.

When a junction node positioned between pixels is retained at a high voltage, the FD node of one pixel may hold part of a charge which overflows from the PD thereof, and is transferred to another adjacent pixel.

Thus, when the FD node is reset to a power supply voltage VDD during the period from the exposure start time to just before the readout time as illustrated in FIG. 2B, in order to control the blooming phenomenon, a high reverse bias voltage is applied to the FD node since the transfer transistor TX is turned off during the period. As a result, leak current may occur in the FD node and degrade the low-illumination properties of the pixel.

### SUMMARY

Various embodiments of the present invention are directed to a pixel apparatus capable of suppressing the degradation of low-illumination properties thereof while improving blooming properties thereof by resetting an FD node from an exposure start time to just before a readout time, an operation method thereof and a CIS using the same.

In other words, various embodiments of the present invention are directed to a pixel apparatus which resets an FD node from an exposure start time to just before a readout time by controlling a reset voltage of the FD node, in order to find an optimal setting condition in a trade-off relation between blooming and low-illumination properties, an operation method thereof and a CIS using the same.

In an embodiment of the present invention, a pixel apparatus may include: a pixel unit suitable for outputting a pixel signal corresponding to incident light; a voltage supply unit suitable for supplying a reset voltage for a floating diffusion (FD) node of the pixel unit; and a voltage switching unit suitable for transferring the reset voltage from the voltage supply unit to the pixel unit during a first period from an exposure start time to just before a readout time, in response to a control signal.

In an embodiment of the present invention, an operation method of a pixel apparatus may include: applying a reset voltage from a voltage supply unit to a drain terminal of a reset transistor during a first period from an exposure start time to just before a readout time, in response to a control signal; and applying a supply voltage to the drain terminal of the reset transistor during a reset period other than the first period, in response to the control signal.

In an embodiment of the present invention, an image sensor may include: a pixel array including a plurality of pixel units, each pixel unit suitable for outputting a pixel signal corresponding to incident light; a voltage supply unit suitable for supplying a reset voltage for a floating diffusion (FD) node of the pixel unit; a voltage switching unit suitable for transferring the reset voltage from the voltage supply unit to the pixel unit during a first period from an exposure start time to just before a readout time, in response to a control signal; and a readout processing unit suitable for reading out the pixel signal outputted from the pixel unit.

In an embodiment of the present invention, an operation method of a pixel apparatus may include: applying a power supply voltage as a reset voltage of a pixel unit during a reset period in response to a control signal; and lowering the reset voltage during a first period from an exposure start time to just before a read out time in response to the control signal, wherein the first period includes a period in which a transfer transistor of he pixel unit is turned off.

### BRIEF DESCRIPTION OF THE DRAWINGS

FIG. 1 is a circuit diagram of a conventional pixel.

FIGS. 2A and 2B are diagrams illustrating sign& readout timings of a conventional pixel and voltage changes of an FD node thereof.

FIG. 3 is a circuit diagram of a pixel apparatus, according to an embodiment of the present invention.

FIG. 4 is a timing diagram of the pixel apparatus shown in FIG. 3.

FIG. 5 is a block diagram of a CIS to which the pixel apparatus of FIG. 3 is applied, according to an embodiment of the present invention.

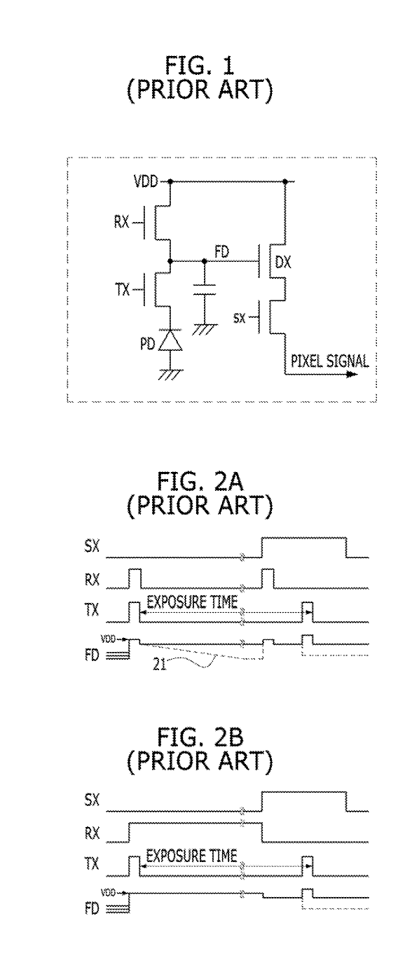

### DETAILED DESCRIPTION

Various embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of the present invention.

Throughout the specification, when an element is referred to as being “coupled” to another element, it may not only indicate that the elements are “directly coupled” to each other, but also indicate that the elements are “electrically coupled” to each other with another element interposed therebetween.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

The terminology used herein is for the purpose of describing particular embodiments only and is not intended to be limiting of the present invention. As used herein, singular forms are intended to include the plural forms as well, unless the context clearly indicates otherwise.

It will be further understood that the terms “comprises”, “comprising”, “includes”, and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

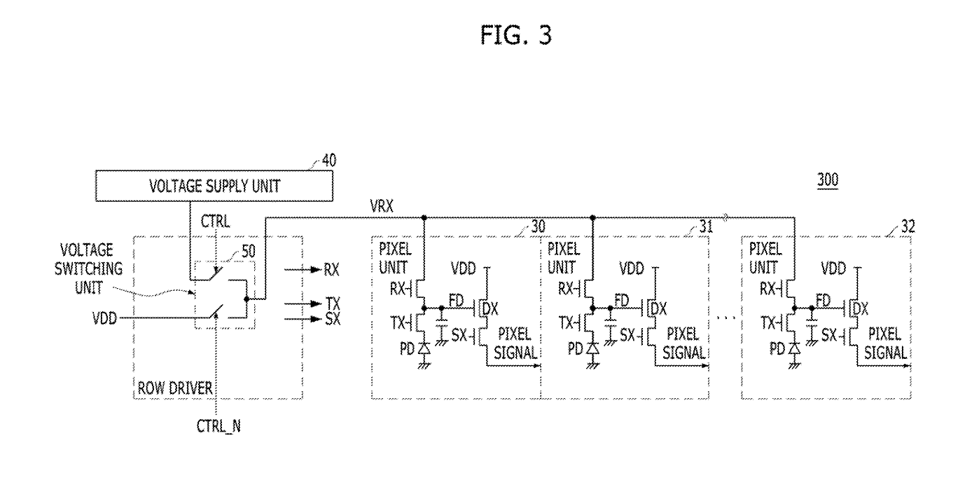

Referring now to FIG. 3, a circuit diagram of a pixel apparatus 300 is provided, according to an embodiment of the present invention.

According to the embodiment of FIG. 3, the pixel apparatus 300 may include pixel units 30 to 32, a voltage supply unit 40 and a voltage switching unit 50. For example, the pixel unit 30 may output a pixel signal corresponding to incident light. The voltage supply unit 40 may supply a reset voltage for an FD node of the pixel unit 30. The voltage switching unit 50 may transfer the reset voltage from the voltage supply unit 40 to the pixel unit 30 during a period from an exposure start time to just before a readout time, in response to a control signal CTRL_N received from an external control unit (not illustrated).

In general, a CIS using the rolling shutter method may have a characteristic according to which the exposure time is changed on a row basis. Thus, for controlling the reset voltage from the exposure start time to just before the readout time at each row, a voltage applied to the drain terminal VRX of a reset transistor RX may be isolated from a voltage applied to the drain terminal of a source follower transistor DX.

In an embodiment of the present invention, the voltage switching unit 50 may be implemented as a row driver which serves to drive a pixel signal. The voltage switching unit 50 and a control signal CTRL for controlling the voltage switching unit 50 may be implemented to apply different voltages to the drain terminal VRX of the reset transistor RX during a period from the exposure start time to just before the readout time and a reset period other than the period, respectively. At this time, the control signal CTRL_N may be an inverted signal of the control signal CTRL. That is, during the period from the exposure start time to just before the readout time, the control signal CTRL may be set in a high state to apply the reset voltage from the voltage supply unit 40 to the drain terminal VRX of the reset transistor RX of the pixel unit 30. Furthermore, during the reset period other than the period from the exposure start time to just before the readout time, the control signal CTRL_N may be set in a high state to apply the power supply voltage VDD to the drain terminal VRX of the reset transistor RX of the pixel unit 30. At this time the control signals CTRL and CTRL_N may be received from the external control unit (for example, timing generator).

Considering a blooming phenomenon, the voltage supply unit 40 may be configured to supply the reset voltage at a level between a half power supply voltage VDD/2 and the power supply voltage VDD. Depending on which method is used for considering a blooming phenomenon, the voltage supply unit 40 may be configured to supply the reset voltage at a level between a ground voltage 0V and the power supply voltage VDD.

The configurations for the above-described reset voltage may be only an example, and an embodiment of the present invention may not be limited to the above aforementioned configurations The reset voltage may be implemented in various manners, provided that the reset voltage is controlled to have a lower value than the power supply voltage VDD.

Even when a global shutter method is used instead of the rolling shutter method, the reset voltage of the FD node may be controlled from the exposure start time to just before the readout time.

In the global shutter method, however, the exposure times of all rows are equal to each other. Thus, unlike the rolling shutter method, voltages applied to the drain terminal VRX of the reset transistor RX and the drain terminal of the source follower transistor DX may not be isolated from each other on a row basis.

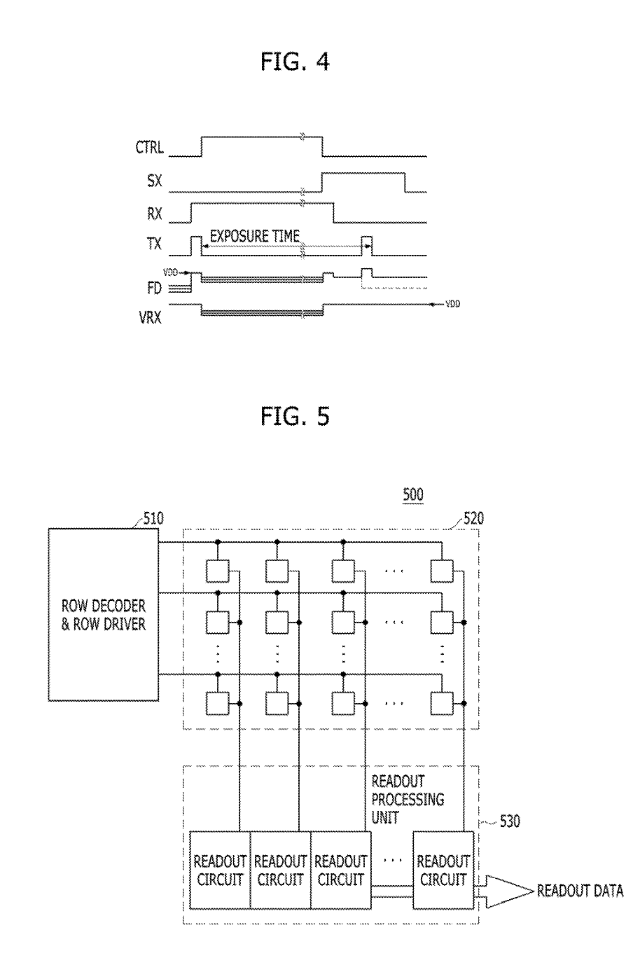

FIG. 4 is a timing diagram of the pixel apparatus shown in FIG. 3.

As illustrated in FIG. 4, the control signal CTRL for controlling the voltage switching unit 50 may be maintained in a high state to control the reset voltage of the FD node, during the period from the exposure start time to just before the readout time.

That is, during the period from the exposure start time to just before the readout time, the control signal CTRL for controlling the voltage switching unit 50 may be maintained in a high state to set the reset voltage (a voltage of a node VRX) at a level between the half power supply voltage VDD/2 and the power supply voltage VDD. Thus, while the blooming properties are improved, the degradation of the low-illumination properties by leak current of the FD node may be suppressed, the leak current occurring when an excessive reverse bias voltage is applied to the FD node.

At this time, during a period in which the transfer transistor TX is operated at a high level, the reset voltage of the FD node (the voltage of the node VRX) may be retained at the level of the power supply voltage VDD. This is because the properties of transferring a charge signal from the PD to the FD node may be affected by the voltage of the FD node.

As described above, embodiments of the present invention may be applied not only to the rolling shutter method, but also to the global shutter method. Furthermore, embodiments of the present invention may be applied not only to a four-transistor pixel apparatus, but also to another type of pixel apparatus.

FIG. 5 is a block diagram of a OS generally designated with numeral 500, according to an embodiment of the present invention. The CIS 500 is employing the pixel apparatus of FIG. 3.

According to the embodiment of FIG. 5, the CIS 500 may include a row decoder and row driver 510, a pixel array 520 and a readout processing unit 530.

The row driver of the row decoder and row driver 510 may drive pixels selected by the row decoder among pixels included in the pixel array 520. For example, the row driver may be or include the voltage switching unit 50 of FIG. 3.

The pixel array 520 may detect light using an optical element, and generate a pixel signal (pixel output signal) corresponding to the detected light. For example, a pixel which is selected by the row decoder and driven by the row driver, among the pixels (pixel units) included in the pixel array 520, may output a pixel signal. The output pixel signal is an analog pixel signal which is an electrical signal, and may include a reset voltage and a signal voltage.

The readout processing unit 530 may read out the pixel signal outputted from the pixel array 520, and output the readout data.

In accordance with an embodiment of the present invention, when resetting an FD node to the power supply voltage VDD for improving blooming properties, the reset voltage of the FD node may be lower than the power supply voltage VDD from the exposure start time to the readout time, for also preventing the low-illumination properties from being degraded by a leak current of the FD node. An excessive reverse bias voltage may be applied to the FD node and the leak current may occur during the period from the exposure start time to the readout time when the transfer transistor is turned off. Thus, while the blooming properties are improved, degradation of the low-illumination properties may also be suppressed.

Although various embodiments of the present invention have been described for illustrative purposes, it will be apparent to those skilled in the art that various changes and modifications may be made without departing from the spirit and scope of the invention as defined in the following claims.

What is claimed is:

1. A pixel apparatus comprising:
a pixel unit suitable for outputting a pixel signal corresponding to incident light;
a voltage supply unit suitable for supplying a reset voltage for a floating diffusion (FD) node of the pixel unit; and
a voltage switching unit suitable for transferring the reset voltage from the voltage supply unit to the pixel unit during a first period from an exposure start time to just before a readout time, in response to a control signal.

2. The unit pixel apparatus of claim 1, wherein the voltage switching unit applies the reset voltage from the voltage supply unit to a drain terminal of a reset transistor of the pixel unit during the first period, and applies a supply voltage to the drain terminal of the reset transistor of the pixel unit during a reset period other than the first period, in response to the control signal.

3. The unit pixel apparatus of claim 1, wherein the voltage supply unit supplies the reset voltage at a voltage level between a half power supply voltage and a power supply voltage.

4. The unit pixel apparatus of claim 1, wherein the voltage supply unit supplies the reset voltage at a voltage level between a ground voltage and a power supply voltage.

5. The pixel of claim 1, further comprising:
a row driver suitable for driving the pixel signal of the pixel unit and including the voltage switching unit.

6. An operation method of a pixel apparatus, comprising:
applying a reset voltage from a voltage supply unit to a drain terminal of a reset transistor during a first period from an exposure start time to just before a readout time, in response to a control signal; and
applying a supply voltage to the drain terminal of the reset transistor during a reset period other than the first period, in response to the control signal.

7. The operation method of claim 6, wherein the reset voltage has a voltage level between a half power supply voltage and a power supply voltage.

8. The operation method of claim 6, wherein the FD node reset voltage has a voltage level between a ground voltage and a power supply voltage.

9. An image sensor comprising:
a pixel array including a plurality of pixel units, each pixel unit suitable for outputting a pixel signal corresponding to incident light;
a voltage supply unit suitable for supplying a reset voltage for a floating diffusion (FD) node of the pixel unit;
a voltage switching unit suitable for transferring the reset voltage from the voltage supply unit to the pixel unit during a first period from an exposure start time to just before a readout time, in response to a control signal; and
a readout processing unit suitable for reading out the pixel signal outputted from the pixel unit.

10. The image sensor of claim 9, wherein the voltage switching unit applies the reset voltage from the voltage supply unit to a drain terminal of a reset transistor of the pixel unit during the first period, and applies a supply voltage to the drain terminal of the reset transistor of the pixel unit during a reset period other than the first period, in response to the control signal.

11. The image sensor of claim 9, wherein the voltage supply unit supplies the reset voltage at a voltage level between a half power supply voltage and a power supply voltage.

12. The image sensor of claim 9, wherein the FD node reset voltage supply unit supplies the reset voltage at a voltage level between a ground voltage and a power supply voltage.

13. The image sensor of claim 9 further comprising:
a row driver suitable for driving the pixel signal of the pixel unit and including the voltage switching unit.

14. An operation method of a pixel apparatus, comprising:
applying a power supply voltage as a reset voltage of a pixel unit during a reset period in response to a control signal; and
lowering the reset voltage during a first period from an exposure start time to just before a read out time in response to the control signal,
wherein the first period includes a period in which a transfer transistor of the pixel unit is turned off.
